(19) United States
(12) Patent Application Publication
(10) Pub. No.: US 2007/0292622 A1
(43) Pub. Date: Dec. 20, 2007

(54) Solvent containing carbon nanotube aqueous dispersions

(76) Inventors: Lawrence A. Rowley, Rochester, NY (US); Glen C. Irvin JR., Rochester, NY (US); Charles C. Anderson, Penfield, NY (US); Sabyasachi Ganguli, Atlanta, GA (US)

Correspondence Address: Paul A. Leipold;Eastman Kodak Company, Patent Legal Staff, 343 State Street, Rochester, NY, 14650-2201, US

(21) Appl. No.: 11/197,235

(22) Filed: Aug. 4, 2005

(51) Int. Cl. D01F 9/12; B05D 7/00

(52) U.S. Cl. 427/407.1; 423/447.1; 977/845

(57) ABSTRACT

The invention relates to a method of forming a dispersion comprising providing functionalized carbon nanotubes with covalently attached hydrophilic species, adding said carbon nanotubes to an aqueous solution of polar solvent, and dispersing said carbon nanotubes in said aqueous solution.

### FIELD OF THE INVENTION

The present invention relates to a method of forming a dispersion of functionalized carbon nanotubes having covalently attached hydrophilic species, wherein the carbon nanotubes are added to an aqueous solution of polar solvent prior to dispersing the carbon nanotubes in the aqueous solution. The method provides a carbon nanotube dispersion having enhanced dispersability and higher percent solids that are suitable for making electrically conductive films or patterned features.

### BACKGROUND OF THE INVENTION

Single wall carbon nanotubes (SWCNTs) are essentially graphene sheets rolled into hollow cylinders thereby resulting in tubules composed of sp² hybridized carbon arranged in hexagons and pentagons, which have outer diameters between 0.4 nm and 10 nm. These SWCNTs are typically capped on each end with a hemispherical fullerene (buckyball) appropriately sized for the diameter of the SWCNT. Although, these end caps may be removed via appropriate processing techniques leaving uncapped tubules. SWCNTs can exists as single tubules or in aggregated form typically referred to as ropes or bundles. These ropes or bundles may contain several or a few hundred SWCNTs aggregated through Van der Waals interactions forming triangular lattices where the tube-tube separation is approximately 3-4 Å. Ropes of SWCNTs may be composed of associated bundles of SWCNTs.

The inherent properties of SWCNTs make them attractive for use in many applications. SWCNTs can possess high (e.g. metallic conductivities) electronic conductivities, high thermal conductivities, high modulus and tensile strength, high aspect ratio and other unique properties. Further, SWCNTs may be either metallic, semi-metallic, or semiconducting dependant on the geometrical arrangement of the carbon atoms and the physical dimensions of the SWCNT. To specify the size and conformation of single-wall carbon nanotubes, a system has been developed, described below, and is currently utilized. SWCNTs are described by an index (n, m), where n and m are integers that describe how to cut a single strip of hexagonal graphite such that its edges join seamlessly when the strip is wrapped into the form of a cylinder. When n=m e.g. (n,n), the resultant tube is said to be of the “arm-chair” or (n, n) type, since when the tube is cut perpendicularly to the tube axis, only the sides of the hexagons are exposed and their pattern around the periphery of the tube edge resembles the arm and seat of an arm chair repeated n times. When m=0, the resultant tube is said to be of the “zig zag” or (n,0) type, since when the tube is cut perpendicular to the tube axis, the edge is a zig zag pattern. Where n≠m and m≠0, the resulting tube has chirality. The electronic properties are dependent on the conformation, for example, arm-chair tubes are metallic and have extremely high electrical conductivity. Other tube types are metallic, semimetals or semi-conductors, depending on their conformation. SWCNTs have extremely high thermal conductivity and tensile strength irrespective of the chirality. The work functions of the metallic (approximately 4.7 eV) and semiconducting (approximately 5.1 eV) types of SWCNTs are different.

Similar to other forms of carbon allotropes (e.g. graphite, diamond) these SWCNTs are intractable and essentially insoluble in most solvents (organic and aqueous alike). Thus, SWCNTs have been extremely difficult to process for various uses. Often, it may be desired to utilize SWCNTs in a pristine state, that is, a state where the SWCNTs are essentially free from defects or surface (internal or external) functionality. Such pristine tubes are intractable in most solvents, and especially aqueous systems. Several methods to make SWCNTs soluble in various solvents have been employed. One approach is to covalently functionalize the ends of the SWCNTs with either hydrophilic or hydrophobic moieties. A second approach is to add high levels of surfactant and/or dispersants (small molecule or polymeric) to help solubilize the SWCNTs.

Haddon et al. in U.S. Pat. No. 6,368,569 disclose a method to solubilize SWCNT and multi-wall carbon nanotubes (MWCNTs) into organic solvents (THF, dichlorobenzene, DMF, chloroform, benzene, toluene etc.) via attaching covalently to the single or multi-wall carbon nanotubes long branched or unbranched aliphatic chains such as long chain amines (e.g. dodecylamine, pentacosylamine etc.). The use of these organic solvents is not desired due to their costs and hazardous nature. The long chain aliphatics are not desired due to the potential of adding high levels of chemical material that are not useful for the uses intended and may interfere with the material properties of the SWCNTs. Such long chain aliphatics may be removed in a post-processing step but such steps add undesired cost and time.

In a recent publication titled Synthesis and Properties of a Water-Soluble Single-Walled Carbon Nanotube-Poly(m-aminobenzene sulfonic acid) (PABS) Graft Copolymer by Bin Zhao, Hui Hu, and Robert Haddon in journal article Advanced Functional Materials 2004, Volume 14, Number 1, p. 71 disclose compositions for functionalized SWCNT electronically conducting materials. Zhao discloses SWCNTs that have PABS covalently grafted onto the walls of the SWCNTs. The conductivity of this functionalized SWCNT was found to be 5.6×10⁻³ S/cm, which is not sufficient for electronic devices.

Connell et al in US Patent Application Publication 2003/0158323 A1 describes a method to produce polymer/SWCNT composites that are electrically conductive and transparent. The polymers (polyimides, copolyimides, polyamide acid, polyaryleneether, polymethylmethacrylate) and the SWCNTs or MWCNTs are mixed in organic solvents (DMF, N,N-dimethlacetamide, N-methyl-2-pyrrolidinone, toluene,) to cast films that have conductivities in the range of 10⁻⁵-10⁻¹² S/cm with varying transmissions in the visible spectrum. Additionally, monomers of the resultant polymers may be mixed with SWCNTs in appropriate solvents and polymerized in the presence of these SWCNTs to result in composites with varying weight ratios. The conductivities achieved in these polymer composites are several orders of magnitude too low and not optimal for use in most electronic devices as electronic conductors or EMI shields. Additionally, the organic solvents used are hazardous, costly and pose problems in processing. Moreover, the polymers used or polymerized are not conductive and can impede tube-tube contact further increasing the resistivity of the composite.

Kuper et al in Publication WO 03/060941A2 disclose compositions to make suspended carbon nanotubes. The compositions are composed of liquids and SWCNTs or MWCNTs with suitable surfactants (cetyl trimethylammonium bromide/chloride/iodide). The ratio by weight of surfactant to SWCNTs given in the examples range from 1.4-5.2. This method is problematic, as it needs extremely high levels of surfactant to solubilize the SWCNTs. The surfactant is insulating and impedes conductivity of a film deposited from this composition. The surfactant may be washed from the film but this step adds complexity and may decrease efficiency in processing. Further, due to the structure formed from a film deposited from such a composition, it would be very difficult to remove all the surfactant.

Smalley et al in U.S. Pat. No. 6,645,455 disclose methods to chemically derivatize SWCNTs to facilitate solvation (dispersion) in various solvents. Primarily the various derivative groups (alkyl chains, acyl, thiols, aminos, aryls etc.) are added to the ends of the SWCNTs. The side-walls of the SWCNTs are functionalized primarily with fluorine groups resulting in fluorinated SWCNTs. The solubility limit of such “fluorotubes” in 2-propanol is approximately 0.1 mg/mL and in water or water/acetone mixtures the solubility is essentially zero. The fluorinated SWCNTs were subjected to further chemical reactions to yield methylated SWCNTs and these tubes have a low solubility in Chloroform but not other solvents. Such low concentrations are impractical and unusable for most deposition techniques useful in high quantity manufacturing. Further, such high liquid loads need extra drying considerations and can destroy patterned images due to intermixing from the excess solvent. In addition, the method discloses functionalization of the tubule ends with various functionalization groups (acyl, aryl, aralkyl, halogen, alkyl, amino, halogen, thiol) but the end functionalization alone may not be enough to produce viable dispersions via solubilization. Further, the side-wall functionalization is done with fluorine only, which gives limited solubility in alcohols, which can make manufacturing and product fabrication more difficult. Additionally, the fluorinated SWCNTs are insulators due to the fluorination and thereby are not useful for electronic devices especially as electronic conductors. Moreover, the chemical transformations needed to add these functional groups to the end points of the SWCNTs require additional processing steps and chemicals which can be hazardous and costly.

Smalley et al. in U.S. Pat. No. 6,683,783 disclose methods to purify SWCNT materials resulting in SWCNTs with lengths from 5-500 nm. Within this patent, formulations are disclosed that use 0.5 wt % of a surfactant, Triton X-100 to disperse 0.1 mg/mL of SWCNT in water. Such low concentrations of SWCNTs are impractical and unusable for most deposition techniques useful in high quantity manufacturing. Further, such high liquid loads need extra drying considerations and can destroy patterned images due to intermixing from the excess solvent. In addition, the method discloses functionalization of the tubule ends with various functionalization groups (acyl, aryl, aralkyl, halogen, alkyl, amino, halogen, thiol) but the end functionalization alone may not be enough to produce viable dispersions via solubilization. Moreover, the chemical transformations needed to add these functional groups to the end points of the SWCNTs require additional processing steps and chemicals which can be hazardous and costly. Also, the patent claims a composition of matter, which is at least 99% by weight of single wall carbon molecules which obviously limits the amount of functionalization that can be put onto the SWCNTs thereby limiting its solubilization levels and processability.

Elkovitch in US Patent Application 2004/0232389A1 discloses conductive compositions produced by dry compounding of carbon nanotubes into a polymer resin using a nanosized dispersing aid. This method is disadvantaged as it only uses dry mixing methods to form the composite, limiting the dispersion effectiveness. Additionally, to disperse the carbon nanotubes well in the polymer matrix, nanoparticles (clays, metal oxides) are used which increases cost.

Rinzler et al. in PCT Publication WO2004/009884 A1 disclose a method of forming SWCNT films on a porous membrane such that it achieves 200 ohms/square and at least 30% transmission at a wavelength of 3 um. This method is disadvantaged since it needs a porous membrane (e.g. polycarbonate or mixed cellulose ester) with a high volume of porosity with a plurality of sub-micron pores as a substrate which may loose a significant amount of the SWCNT dispersion through said pores thereby wasting a significant amount of material. Also, such membranes may not have the optical transparency required for many electronic devices such as displays. Further, the membrane is set within a vacuum filtration system which severely limits the processability of such a system and makes impossible roll coating application of the SWCNT solution. Moreover, the weight percent of the dispersion used to make the SWCNT film was 0.005 mg/mL in an aqueous solution. Such weight percents are impractical and unusable in most coating and deposition systems with such a high liquid load. Such high liquid loads make it virtually impossible to make patterned images due to solvent spreading and therefore image bleeding/destruction.

Chen in EP1359169A2 and EP1359121A2 disclose materials and methods to solubilize SWCNTs. Rigid backbone polymers are described that are used to noncovalently bond with a carbon nanotube substantially along the nanotube's length, as opposed to about its diameter.

Arthur et al in PCT Publication WO 03/099709 A2 disclose methods for patterning carbon nanotubes coatings. Dilute dispersions (10 to 100 ppm) of SWCNTs in isopropyl alcohol (IPA) and water (which may include viscosity modifying agents) are spray coated onto substrates. After application of the SWCNT coating, a binder is printed in imagewise fashion and cured. Alternatively, a photo-definable binder may be used to create the image using standard photolithographic processes. Materials not held to the substrate with binder are removed by washing. Dilute dispersions (10 to 100 ppm) of SWCNTs in isopropyl alcohol (IPA) and water with viscosity modifying agents are gravure coated onto substrates. Dilute dispersions (10 to 100 ppm) of SWCNTs in isopropyl alcohol (IPA) and water are spray coated onto substrates. The coated films are then exposed through a mask to a high intensity light source in order to significantly alter the electronic properties of the SWCNTs. This step is followed by a binder coating. The dispersion concentrations used in these methods make it very difficult to produce images via direct deposition (inkjet etc.) techniques. Further, such high solvent loads due to the low solids dispersions create long process times and difficulties handling the excess solvent. In addition, these patterning methods are subtractive processes, which unnecessarily waste the SWCNT material via additional removal steps thereby incurring cost and process time. This application also discloses method to make conductive compositions and coatings from such compositions but it does not teach satisfactory methods nor compositions to execute such methods.

As indicated above, the art discloses a wide variety of SWCNT dispersion schemes and compositions. However, there is still a critical need in the art for aqueous SWCNT compositions that are stable, with increased solid loadings using minimal dispersants in order to facilitate high speed, high volume coating techniques such as ink jet printing, roll coating, and offset printing while retaining high conductivity and transparency.

It is toward the objective of providing such improved electronically conductive, patternable, preferably web coatable, functionalized SWCNTs and functionalized SWCNT compositions that more effectively meet the diverse commercial needs than those of the prior art that the present invention is directed.

### PROBLEM TO BE SOLVED BY THE INVENTION

The problem to be solved by this invention is the need for high levels of permanent dispersants typically used in aqueous dispersions of carbon nanotubes. Such prior art permanent dispersants may disrupt the point-to-point contact of adjacent carbon nanotubes in the dried layer leading to diminished conductivity.

### SUMMARY OF THE INVENTION

The present invention provides a method of forming a dispersion of functionalized carbon nanotubes having covalently attached hydrophilic species, herein the said carbon nanotubes are added to an aqueous solution of polar solvent, and then dispersing said carbon nanotubes in the aqueous solution.

The invention further provides a coating composition and dried film of carbon nanotubes with enhanced properties arising from the use of such aqueous solutions of polar solvents, said polar solvents function as a volatile dispersant and coating aid.

### ADVANTAGEOUS EFFECT OF THE INVENTION

The invention provides a facile method to produce stable, high solids carbon nanotube coating compositions that are essentially free of permanent dispersants. Coating compositions of the invention provide highly conductive carbon nanotube dried films.

These and other advantages will be apparent from the detailed description given below.

### BRIEF DESCRIPTION OF THE DRAWINGS

FIG. 1 shows a pristine SWCNT with either open or closed ends.

FIG. 2 shows a covalently functionalized SWCNT with either open or closed ends.

FIG. 3 shows the plot of Polar Solubility Parameter vs. Surface Tension for various solvents and indicates the space of interest as a shaded area.

FIG. 4 shows the plot of Hydrogen Bonding Solubility Parameter vs. Surface Tension for various solvents and indicates the space of interest as a shaded area.

FIG. 5 shows the plot of Hydrogen Bonding Solubility Parameter vs. Polar Solubility Parameter for various solvents and indicates the space of interest as a shaded area.

### DETAILED DESCRIPTION OF THE INVENTION

The method in accordance with the present invention involves the dispersion method, coating and subsequent drying of a coating composition containing functionalized carbon nanotubes. The present invention provides stable, high solids carbon nanotube dispersions and coating compositions that permit easy deposition and film formation suitable for producing highly conductive and highly transparent films.

Suitable dispersion processes useful in the invention may employ a high shear mixing apparatus (homogenizer, microfluidizer, cowles blade high shear mixer, automated media mill, ball mill) for several minutes to several hours or ultrasonication and bath sonication for about 2-24 hrs. Preferably, the dispersion process used in the invention is ultrasonication and bath sonication.

The dispersion method of the invention involves providing carbon nanotubes and dispersing into an aqueous solution of polar solvent. Optionally, a polymeric binder may be provided to the mixture. Dispersing energy is provided to this mixture until the carbon nanotubes are sufficiently dispersed within the liquid medium. A standard time for bath sonication is about 2-24 hrs (dependant on the level of hydrophilic functionalization and polar solvent selection). Before, during or after the dispersion process, pH can be adjusted to desired range. A centrifugation or filtration process is used to remove large particulates. After the centrifugation or filtration step, pH may again be adjusted. The resultant dispersion will be stable for several months on standing (dependant on the level of hydrophilic functionalization). This dispersion has solids loadings high enough to produce conductive coatings in single pass modes for typical coating techniques employed.

The carbon nanotubes may be formed by any known methods in the art (laser ablation, CVD, arc discharge). Preferably the carbon nanotubes are single wall carbon nanotubes (SWCNTs). These SWCNTs are preferred to have minimal or no impurities of metals that may be used in such synthetic methods and carbonaceous impurities that are not single wall carbon nanotubes (graphite, amorphous, diamond, non-tubular fullerenes, multiwall carbon nanotubes). It is found that the transparency increases significantly with the decrease of metallic and carbonaceous impurities. The film quality as evidenced by layer uniformity, surface roughness, and a reduction in particulates also improves with a decrease in the amount of metallic and carbonaceous impurities.

To achieve high electronic conductivity, metallic SWCNTs are the most preferred type but semimetallic and semiconducting may also be used. A pristine SWCNT means that the surface of the SWCNT is free of covalently functionalized materials either through synthetic prep, acid cleanup of impurities, annealing or directed functionalization. Polar solvent mixtures in combination with SWCNT functionalization is the preferred embodiment of this invention; preferably the functional group is a hydrophilic species selected from carboxylic acid, carboxylate anion (carboxylic acid salt), hydroxyl, sulfur containing groups, carbonyl, phosphates, nitrates or combinations of these hydrophilic species.

Sulfur containing groups may contain sulfenic acid, sulfinic acid and/or sulfonic acid and/or the corresponding anions or mixtures thereof. In some applications other types of functionalization such as polymer, small molecule or combinations thereof may be required. For example, such functionalization may improve the compatibility of the SWCNT in a particular polymer matrix. However, such functionalization schemes do not provide the high solids loading needed for coating compositions that are necessary to produce high conductivity and high transparency films.

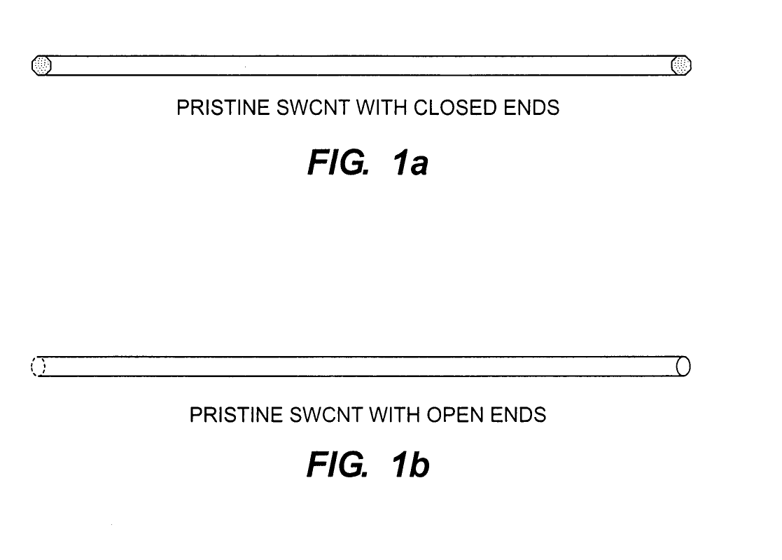

Turning to FIG. 1, pristine SWCNTs with either open or closed ends are illustrated. SWCNTs that are pristine are essentially intractable in most solvents, especially aqueous, without the use of high levels of dispersants.

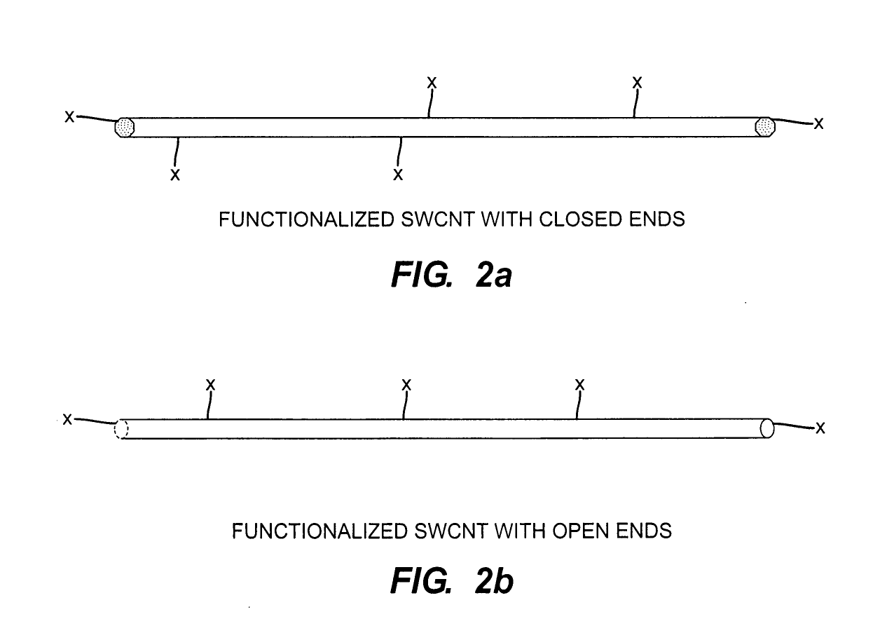

Therefore, it is not possible to use only pristine SWCNTs and water to produce an aqueous coating composition. FIG. 2 exemplifies the basic structure of covalently functionalized SWCNTs. The X in FIG. 2 may be selected from one of the hydrophilic species listed above. It is worth noting that the X may be positioned at any point on the SWCNT, external or internal surface, open or closed end, or sidewall. It is preferred that the X be uniformly distributed across the external surface, potentially for the most effectiveness.

The most preferred covalent surface functionalization is carboxylic acid or a carboxylic acid salt or mixtures thereof (hereafter referred to as only carboxylic acid). For carboxylic acid based functionalization, the preferred level of functionalized carbons on the SWCNT is 0.5-100 atomic percent, where the term atomic percent is defined such that 1 atomic percent functionalized carbons would be 1 out of every 100 carbons in the SWCNT have a functional group covalently attached. The functionalized carbons may exist anywhere on the nanotubes (open or closed ends, external and internal sidewalls). As already mentioned, preferably the functionalization is on the external surface of the SWCNTs. More preferably the functionalized percent range is 0.5-50 atomic percent, and most preferably 0.5-20 atomic percent. Functionalization of the SWCNTs with these groups within these atomic percent ranges allows the preparation of stable dispersions at the solids loadings necessary to form highly conductive, transparent films by conventional coating means. This coating composition allows for very effective dispersion in substantially aqueous dispersions and does not require a dispersion aid. Transparency is defined as a layer that has greater than 60% bulk transmission of light in the visible wavelength regime. The functionalization may be carried out by a number of routes.

Typically, the raw material (unfunctionalized) SWCNTs are added to a bath of strongly oxidizing agents (hydrochloric acid, hydrofluoric acid, hydrobromic acid, hydroiodic acid, sulfuric acid, oleum, nitric acid, citric acid, oxalic acid, chlorosulfonic acid, phosphoric acid, trifluoromethane sulfonic acid, glacial acetic acid, monobasic organic acids, dibasic organic acids, potassium permanganate, persulfate, cerate, bromate, hydrogen peroxide, dichromate) which may be mixtures. Temperatures from 20° C.-120° C. are typically used in reflux of this mixture of SWCNTs and strong oxidizing agents with appropriate agitation over 1 hr—several days process time. At the end of this process, the raw SWCNTs are now functionalized SWCNTs. The residual oxidizing agents are removed via separation technologies (filtration wash, centrifugation, cross-flow filtration) such that a powder of the functionalized SWCNTs (primarily carboxylic acid functionalities) remains after appropriate heating to dry.

The pH of the dispersion and the coating composition is important. As the pH becomes higher (above the pKa of the carboxylic acid groups), the carboxylic acid will be ionized thereby making the carboxylate anion, a bulky, repulsive group which can aid in the stability. Preferred pH ranges from 3-10 pH. More preferred pH ranges from 3-6.

The length of the SWCNTs may be from 20 nm-1 m. The SWCNTs may exist as individual SWCNTs or as bundles of SWCNTs. The diameter of a SWCNT in the conductive layer may be 0.5 nm-5 nm. The SWCNTs in bundled form may have diameters ranging from 1 nm-1 um. Preferably such bundles will have diameters less than 50 nm and preferably less than 20 nm. It is important that higher surface area is achieved to facilitate transfer of electrons and higher available surface area is achieved by having smaller bundle sizes thereby exposing surfaces of SWCNTs which may be at the internal position of the bundles and not accessible. The ends of the SWCNTs may be closed by a hemispherical buckyball of appropriate size. Alternatively, both of the ends of the SWCNTs may be open. Some cases may find one end open and the other end closed.

The functionalized SWCNTs (produced as described above or purchased from a vendor) are used to form substantially aqueous dispersions with solids loadings in the range 0.05 wt % to 10 wt %. The preferred range of the solids loadings is 0.05 wt % to 5 wt %. The most preferred range is 0.05 wt % to 1 wt. This preferred range gives the most stable dispersions that have high enough wt % nanotubes to coat by conventional methods onto a substrate. Substantially aqueous means at least 50 wt % of water in the dispersion. The functionalized SWCNTs are often in powder/flake form and require energy to disperse.

In the practice of the present invention, polar solvents are employed as volatile dispersants and coating aids. As used in the present invention, a volatile dispersant is a dispersing agent that provides stabilization in the solution state but is removed during conventional processing of dispersions into coatings and in particular at the conventional drying conditions such that the volatile dispersant is removed from the resultant coating. A permanent dispersant is likewise used to provide solution stabilization, but remains as part of the resultant coating.

It is well known in the paint and coating industry that organic solvents may be classified by their solubility parameter. The solubility parameter is defined as the square root of the cohesive energy density and is expressed in units of (MPa)^{1/2}, such units are often referred to as a “Hildebrand” (see Rodriguez, Ferdinand, 1989 “Principles of Polymer Systems”—3^{rd} ed. Pg. 28-37). The solubility parameters can be broken into three components representing nonpolar, polar, and hydrogen-bonding contributions. The present inventors have found that these solubility components are critical in defining the characteristic properties from which the preferred solvents of this invention are chosen.

TABLE 1
Physical Properties of Selected Solvents

| | | Evaporation | | | Polar | Hydrogen |
|---|---|---|---|---|---|---|
| | | Rate (relative | Surface | | Solubility | Solubility |
| | BP | to n-butyl | Tension | M.W. | Parameter | Parameter |
| Solvent Vehicles | (° C.) | acetate) | (mN/m) | (g/mol) | (MPa)^{1/2} | (MPa)^{1/2} |
| Water | 100 | 82.86 | 72 | 18 | 22.75 | 47.98 |
| Acetone | 56.5 | 1447.78 | 23.5 | 58.08 | 9.80 | 11.03 |
| Methanol | 64.5 | 590.18 | 22.07 | 34.04 | 13.01 | 24.00 |
| MEK | 79.5 | 630.64 | 24.6 | 72.1 | 9.25 | 9.47 |
| Ethanol | 78.3 | 330.03 | 22 | 46 | 11.17 | 20.01 |
| IPA | 82.3 | 283.42 | 23 | 60.1 | 9.80 | 15.98 |
| n-propanol | 97.2 | 130.44 | 23.7 | 60.1 | 10.54 | 17.68 |
| Ethylene Glycol | 197.6 | 0.36 | 48 | 62.07 | 15.08 | 29.79 |
| Diethylene Glycol | 245.8 | 0.01 | 44.7 | 106.1 | 12.28 | 23.32 |
| THF | 67 | 1226.9 | 26.4 | 72.1 | 10.97 | 6.65 |
| Glycerol | 290.1 | 0 | 64 | 92.06 | 15.41 | 31.41 |
| Dowanol PM (1- | 120 | N/A | 27.7 | 90.1 | 14.73 | 27.83 |
| methoxy-2-propanol) | | | | | | |
| n-butanol | 117.7 | 45.73 | 24.6-25.4 | 74.12 | 10.00 | 15.45 |
| sec-butanol | 99.5 | 124.69 | 22.57 | 74.12 | 9.13 | 14.79 |
| tert-butanol | 82.4 | N/A | 19.96 | 74.12 | N/A | N/A |
| isobutanol (2-methyl- | 108 | 81.69 | 23 | 74.12 | 9.80 | 14.96 |
| 1-propanol) | | | | | | |
| Butyl Cellosolve | 171.2 | 7.79 | N/A | 118.18 | 7.94 | 12.99 |

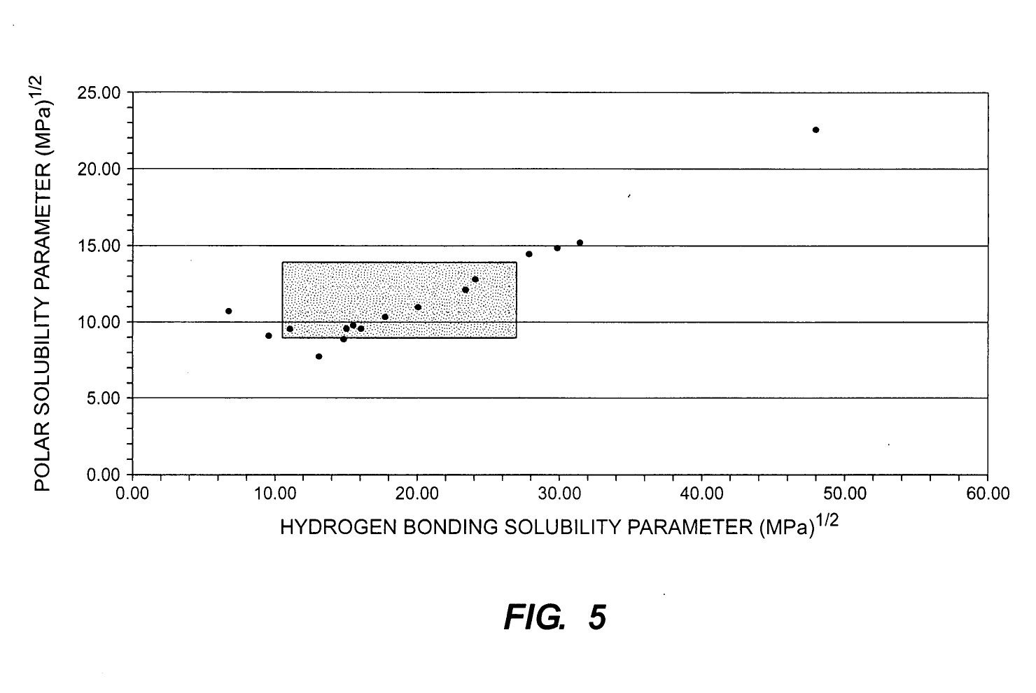

Preferred polar solvents for the purpose of the present invention have a hydrogen-bonding solubility parameter of between 8 and 27 (MPa)^{1/2} and have a polar solubility parameter of between 8.1 and 14.4 (MPa)^{1/2}. Referring now to FIG. 5, which shows a plot of suitable hydrogen bonding solubility parameter and polar solubility parameter combinations for various solvents that provide desirable dispersion and coating properties.

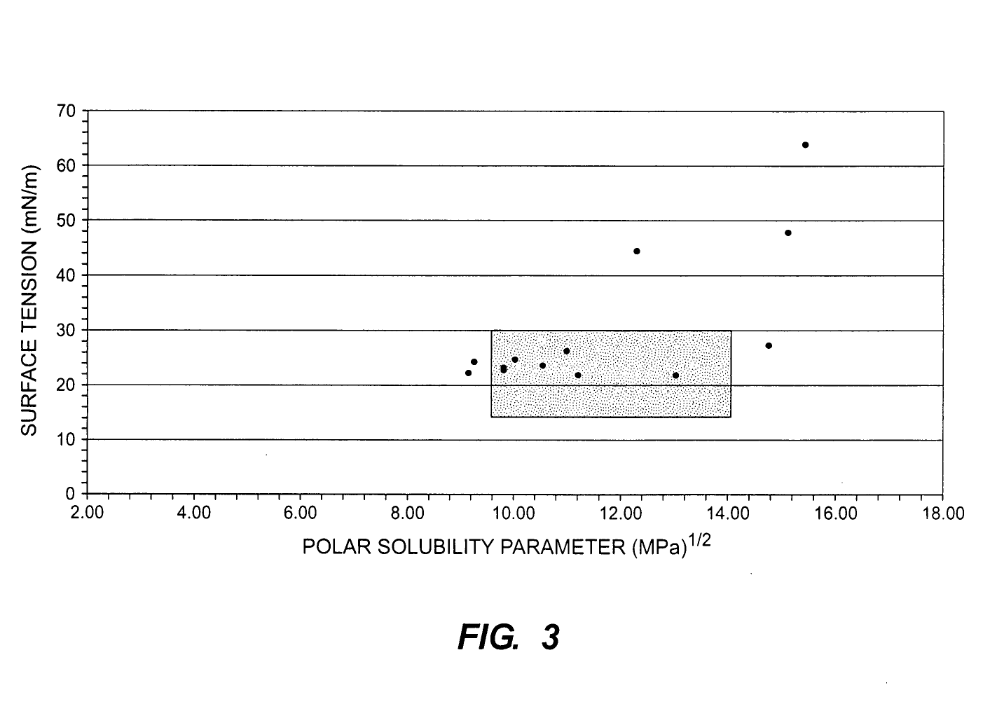

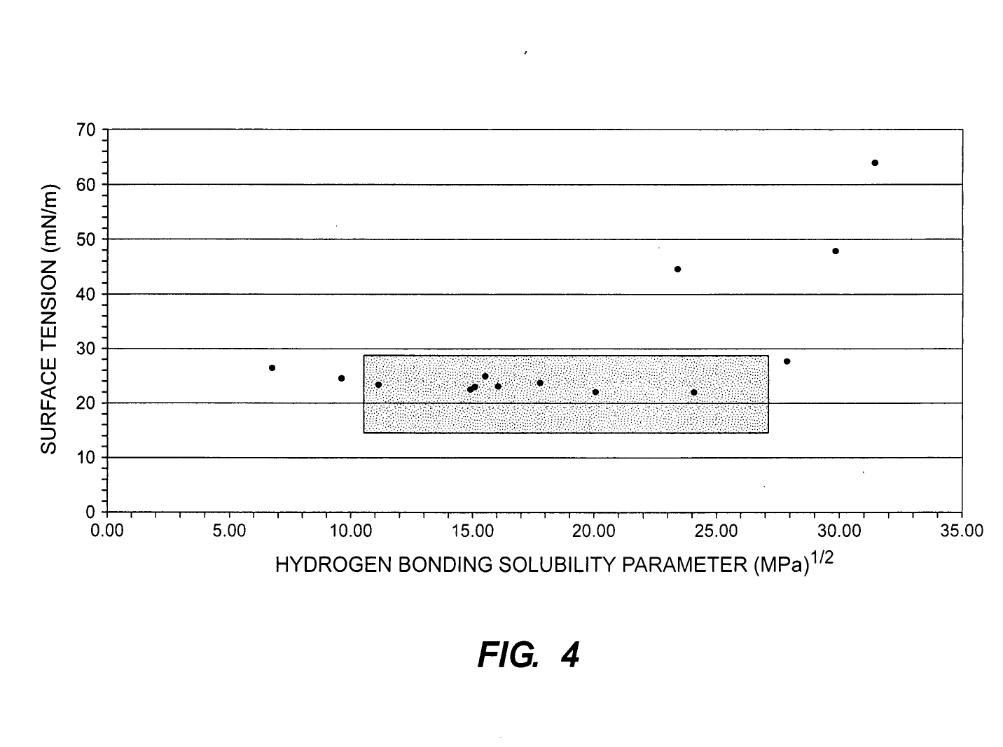

Most preferably, solvents having these solubility parameters also have a surface tension of between 14 and 30 milliNewtons per meter (mN/m). Referring now to FIG. 4, which shows a plot of suitable surface tension and hydrogen bonding solubility parameter combinations for various solvents that provide desirable dispersion and coating properties. Referring now to FIG. 3, which shows a plot of suitable surface tension and polar solubility parameter combinations for various solvents that provide desirable dispersion and coating properties. Not being bound by theory, it is believed that surface tension in the specified ranges provide improved dispersability via intercalating between the bundles of carbon nanotubes and improving the dispersion of the carbon nanotubes. Additionally, not being bound by theory, the selected polar and hydrogen bonding solubility parameters are believed to enhance dispersion via polar and hydrogen bonding interactions with the hydrophilic functionalized carbon nanotubes. Suitable solvents useful in the instant invention are selected from methanol, isopropyl alcohol, n-propyl alcohol, ethanol, acetone, and mixtures thereof. Furthermore, it is desirable from a coating and drying efficiency standpoint to select solvents within an evaporation rate range between 50 and 2000 relative to n-butyl acetate.

The dispersion of this invention can be used to form a conductive layer, where the conductive layer of the invention should contain about 0.1 to about 1000 mg/m² dry coating weight of the functionalized SWCNT. Preferably, the conductive layer should contain about 0.5 to about 500 mg/m² dry coating weight of the functionalized SWCNT. The actual dry coating weight of the SWCNTs applied is determined by the properties for the particular conductive functionalized SWCNT employed and by the requirements for the particular application, the requirements may include, for example, the conductivity, transparency, optical density, cost, etc for the layer.

The conductive layer may be employed for either electronic or thermal conduction or both. It is preferred that the conductive layer have electronic conductivity ranging from 100-10,000 Siemens/cm over a range of temperatures. This electrically conductive layer may be a continuous layer or patterned according to a predetermined structure.

In a preferred embodiment the conductive layer will have a thermal conductivity ranging from 100-50,000 W/m-K over a range of temperatures. This thermally conductive layer may be a continuous or patterned layer according to a predetermined structure.

In a preferred embodiment, the layer containing the conductive SWCNTs is prepared by applying a mixture containing:

a) a SWCNT according to Formula I; 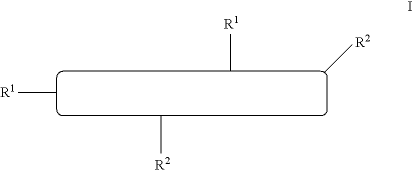
wherein each of R¹ and R² independently represents carboxylic acid, carboxylate anion (carboxylic acid salt), hydroxyl, sulfur containing groups, carbonyl, phosphates, nitrates, and the tube is a single wall carbon nanotube composed of carbon atoms substantially in hexagonal configuration, and, optionally

b) a dispersant and, optionally

c) a polymeric binder.

The R¹ and R² substituents may be uniformly or non-uniformly distributed across the SWCNT. The dispersant loading in the dispersion is preferred to be minimal to none. The maximum dispersant loading is preferred to be 20 wt % of the weight of the SWCNT. Typically the dispersant loading is less than 10 wt % of the weight of the SWCNT. The most preferred dispersant loading is less than 1 wt % of the weight of the SWCNT. There are many dispersants which may be chosen.

Preferred dispersants are TX-100, sodium dodecyl sulfate, sodium dodecylbenzenesulfonate, poly(styrene sulfonate), sodium salt, poly(vinylpyrrolidone), Pluronics, Brij 78, Brij 700, and cetyl or dodecyltrimethylammonium bromide. Appropriate mixtures of these dispersants may be utilized.

Additionally, a preferred embodiment for functionalization of this invention can preferably be where the hydrophilic species is a sulfur containing group selected from:
SOₓZ_{y}
x may range from 1-3 and Z may be a Hydrogen atom or a metal cation such metals as Na, Mg, K, Ca, Zn, Mn, Ag, Au, Pd, Pt, Fe, Co and y may range from 0 or 1. The sulfur containing groups listed above may be sulfenic acid, sulfinic acid and/or sulfonic acid and/or the corresponding anions or mixtures thereof. The most preferred sulfur containing group for covalent surface functionalization is sulfonic acid or a sulfonic acid salt or mixtures thereof.

For environmental reasons, substantially aqueous systems (meaning at least 60 wt % water in the dispersion) are preferred. While the SWCNTs can be applied without the addition of a polymeric binder, preferably, a binder is employed to improve adhesion, film formation, smoothing, and the physical properties of the layer and/or to improve the absorption of the coating composition. In such a preferred embodiment, the conductive layer may comprise from about 0.05 to 98% of the polymeric binder. The preferred range of polymeric binder is 0.10% to 50.0%. The optimum weight percent of polymeric binder varies depending on the electrical properties of the functionalized SWCNTs, the chemical composition of the polymeric binder, and the requirements for the particular application.

Polymeric binders useful in the conductive layer of this invention can include, but are not limited to, water-soluble or water-dispersible hydrophilic polymers such as gelatin, gelatin derivatives, maleic acid or maleic anhydride copolymers, cellulose derivatives (such as carboxymethyl cellulose, hydroxyethyl cellulose, cellulose acetate butyrate, diacetyl cellulose, and triacetyl cellulose), polyvinyl alcohol, and poly-N-vinylpyrrolidone. Other suitable binders include aqueous emulsions of addition-type homopolymers and copolymers prepared from ethylenically unsaturated monomers such as acrylates including acrylic acid, methacrylates including methacrylic acid, acrylamides and methacrylamides, itaconic acid and its half-esters and diesters, styrenes including substituted styrenes, acrylonitrile and methacrylonitrile, vinyl acetates, vinyl ethers, vinyl and vinylidene halides, and olefins and aqueous dispersions of polyurethanes or polyesterionomers. Additionally, latex systems may be used as the binder. The latex particle size may range from 10 nm-100 um, depending on the application.

When employing aqueous coating compositions for the purpose of the present invention it is preferred to utilize hydrophilic film-forming polymeric binders such as gelatin, gelatin derivatives, cellulose derivatives, polyvinyl alcohol, polystyrene sulfonic acid, sulfonic acid sodium salt polyester ionomers and aqueous polyurethanes.

Other ingredients that may be included in the layer or coating composition containing the functionalized SWCNT include but are not limited to antiblocking agents, surfactants or coating aids, thickeners or rheology modifiers, hardeners or crosslinking agents, biocides, humectants and antidrying agents, stabilizers, pigments or dyes, lubricating agents, wetting aids, and various other conventional coating additives readily apparent to one skilled in the art. Dyes and pigments may be used in the printing solution when it is desirable to provide a visual record of the printed electrode pattern.

After depositing the film in continuous or patterned form the layer may be dried at temperatures ranging from room temperature to about 250° C.

The layer containing the SWCNT may be applied onto a variety of substrates depending on the intended use. The conductive layer of the invention can be formed on any rigid or flexible substrate. Rigid substrates can include glass, metal, ceramic and/or semiconductors. Suitable substrates include; glass, polymeric films such as polyester, polycarbonate, polystyrene, cellulose esters, polyolefins, and other well known polymer films, paper, silicon wafers, glass reinforced epoxy, etc. The conductive layer may be applied using any suitable coating method such as spin coating, hopper coating, roller coating, air knife coating, etc.

The substrates can be transparent, reflective, translucent or opaque, and may be colored or colorless. Flexible substrates, especially those comprising a plastic substrate, are preferred for their versatility and ease of manufacturing, coating and finishing.

The flexible plastic substrate can be any flexible self-substrating plastic film that substrates the conductive polymeric film. “Plastic” means a high polymer, usually made from polymeric synthetic resins, which may be combined with other ingredients, such as curatives, fillers, reinforcing agents, colorants, and plasticizers. Plastic includes thermoplastic materials and thermosetting materials.

The flexible plastic film must have sufficient thickness and mechanical integrity so as to be self-supporting, yet should not be so thick as to be rigid. Another significant characteristic of the flexible plastic substrate material is its glass transition temperature (Tg). Tg is defined as the glass transition temperature at which plastic material will change from the glassy state to the rubbery state. It may comprise a range before the material may actually flow. Suitable materials for the flexible plastic substrate include thermoplastics of a relatively low glass transition temperature, for example up to 150° C., as well as materials of a higher glass transition temperature, for example, above 150° C. The choice of material for the flexible plastic substrate would depend on factors such as manufacturing process conditions, such as deposition temperature, and annealing temperature, as well as post-manufacturing conditions such as in a process line of a displays manufacturer. Certain of the plastic substrates discussed below can withstand higher processing temperatures of up to at least about 200° C., some up to 300°-350° C., without damage.

Typically, the flexible plastic substrate is a polyester including polyethylene terephthalate (PET), polyethylene naphthalate (PEN), polyester ionomer, polyethersulfone (PES), polycarbonate (PC), polysulfone, a phenolic resin, an epoxy resin, polyester, polyimide, polyetherester, polyetheramide, cellulose nitrate, cellulose acetate, poly(vinyl acetate), polystyrene, polyolefins including polyolefin ionomers, polyamide, aliphatic polyurethanes, polyacrylonitrile, polytetrafluoroethylenes, polyvinylidene fluorides, poly(methyl(x-methacrylates), an aliphatic or cyclic polyolefin, polyarylate (PAR), polyetherimide (PEI), polyethersulphone (PES), polyimide (PI), Teflon poly(perfluoro-alboxy)fluoropolymer (PFA), poly(ether ketone) (PEEK), poly(ether ketone) (PEK), poly(ethylene tetrafluoroethylene)fluoropolymer (PETFE), and poly(methyl methacrylate) and various acrylate/methacrylate copolymers (PMMA) natural and synthetic paper, resin-coated or laminated paper, voided polymers including polymeric foam, microvoided polymers and microporous materials, or fabric, or any combinations thereof.

Aliphatic polyolefins may include high density polyethylene (HDPE), low density polyethylene (LDPE), and polypropylene, including oriented polypropylene (OPP). Cyclic polyolefins may include poly(bis(cyclopentadiene)).

A preferred flexible plastic substrate is a cyclic polyolefin or a polyester. Various cyclic polyolefins are suitable for the flexible plastic substrate. Examples include Arton® made by Japan Synthetic Rubber Co., Tokyo, Japan; Zeanor T made by Zeon Chemicals L. P., Tokyo Japan; and Topas® made by Celanese A. G., Kronberg Germany. Arton is a poly(bis(cyclopentadiene)) condensate that is a film of a polymer. Alternatively, the flexible plastic substrate can be a polyester. A preferred polyester is an aromatic polyester such as Arylite. Although the substrate can be transparent, translucent or opaque, for most display applications transparent members comprising transparent substrate(s) are preferred. Although various examples of plastic substrates are set forth above, it should be appreciated that the flexible substrate can also be formed from other materials such as flexible glass and ceramic.

The flexible plastic substrate can be reinforced with a hard coating.

Typically, the hard coating is an acrylic coating. Such a hard coating typically has a thickness of from 1 to 15 microns, preferably from 2 to 4 microns and can be provided by free radical polymerization, initiated either thermally or by ultraviolet radiation, of an appropriate polymerizable material. Depending on the substrate, different hard coatings can be used. When the substrate is polyester or Arton, a particularly preferred hard coating is the coating known as “Lintec.” Lintec contains UV cured polyester acrylate and colloidal silica. When deposited on Arton, it has a surface composition of 35 atom % C, 45 atom % 0, and 20 atom % Si, excluding hydrogen. Another particularly preferred hard coating is the acrylic coating sold under the trademark “Terrapin” by Tekra Corporation, New Berlin, Wis.

The most preferred flexible plastic substrate is a polyester because of its superior mechanical and thermal properties as well as its availability in large quantity at a moderate price. The particular polyester chosen for use can be a homo-polyester or a co-polyester, or mixtures thereof as desired. The polyester can be crystalline or amorphous or mixtures thereof as desired. Polyesters are normally prepared by the condensation of an organic dicarboxylic acid and an organic diol and, therefore, illustrative examples of useful polyesters will be described herein below in terms of these diol and dicarboxylic acid precursors. Polyesters which are suitable for use in this invention are those which are derived from the condensation of aromatic, cycloaliphatic, and aliphatic diols with aliphatic, aromatic and cycloaliphatic dicarboxylic acids and may be cycloaliphatic, aliphatic or aromatic polyesters. Exemplary of useful cycloaliphatic, aliphatic and aromatic polyesters which can be utilized in the practice of their invention are poly(ethylene terephthalate), poly(cyclohexlenedimethylene), terephthalate) poly(ethylene dodecate), poly(butylene terephthalate), poly(ethylene naphthalate), poly(ethylene(2,7-naphthalate)), poly(methaphenylene isophthalate), poly(glycolic acid), poly(ethylene succinate), poly(ethylene adipate), poly(ethylene sebacate), poly(decamethylene azelate), poly(ethylene sebacate), poly(decamethylene adipate), poly(decamethylene sebacate), poly(dimethylpropiolactone), poly(para-hydroxybenzoate) (Ekonol), poly(ethylene oxybenzoate) (A-tell), poly(ethylene isophthalate), poly(tetramethylene terephthalate, poly(hexamethylene terephthalate), poly(decamethylene terephthalate), poly(1,4-cyclohexane dimethylene terephthalate) (trans), poly(ethylene 1,5-naphthalate), poly(ethylene 2,6-naphthalate), poly(1,4-cyclohexylene dimethylene terephthalate), (Kodel) (cis), and poly(1,4-cyclohexylene dimethylene terephthalate (Kodel) (trans).

Polyester compounds prepared from the condensation of a diol and an aromatic dicarboxylic acid is preferred for use in this invention. Illustrative of such useful aromatic carboxylic acids are terephthalic acid, isophthalic acid and an α-phthalic acid, 1,3-napthalenedicarboxylic acid, 1,4 napthalenedicarboxylic acid, 2,6-napthalenedicarboxylic acid, 2,7-napthalenedicarboxylic acid, 4,4′-diphenyldicarboxylic acid, 4,4′-diphenysulfphone-dicarboxylic acid, 1,1,3-trimethyl-5-carboxy-3-(p-carboxyphenyl)-idane, diphenyl ether 4,4′-dicarboxylic acid, bis-p(carboxy-phenyl) methane, and the like. Of the aforementioned aromatic dicarboxylic acids, those based on a benzene ring (such as terephthalic acid, isophthalic acid, orthophthalic acid) are preferred for use in the practice of this invention. Amongst these preferred acid precursors, terephthalic acid is particularly preferred acid precursor.

Preferred polyesters for use in the practice of this invention include poly(ethylene terephthalate), poly(butylene terephthalate), poly(1,4-cyclohexylene dimethylene terephthalate) and poly(ethylene naphthalate) and copolymers and/or mixtures thereof. Among these polyesters of choice, poly(ethylene terephthalate) is most preferred.

The aforesaid substrate useful for application in display devices can be planar and/or curved. The curvature of the substrate can be characterized by a radius of curvature, which may have any value. Alternatively, the substrate may be bent so as to form an angle. This angle may be any angle from 0° to 360°, including all angles therebetween and all ranges therebetween. If the substrate is electrically conducting, an insulating material such as a non-conductive polymer may be placed between the substrate and the conducting polymer.

The substrate may be of any thickness, such as, for example. 10⁻⁸ cm to 1 cm including all values in between and all ranges therebetween. Thicker and thinner layers may be used. The substrate need not have a uniform thickness. The preferred shape is square or rectangular, although any shape may be used.

Before the substrate is coated with the conducting polymer it may be physically and/or optically patterned, for example by rubbing, by the application of an image, by the application of patterned electrical contact areas, by the presence of one or more colors in distinct regions, by embossing, microembossing, microreplication, etc.

The aforesaid substrate can comprise a single layer or multiple layers according to need. The multiplicity of layers may include any number of auxiliary layers such as antistatic layers, tie layers or adhesion promoting layers, abrasion resistant layers, curl control layers, conveyance layers, barrier layers, splice providing layers, UV absorption layers, optical effect providing layers, such as antireflective and antiglare layers, waterproofing layers, adhesive layers, imaging layers and the like.

The polymer substrate can be formed by any method known in the art such as those involving extrusion, coextrusion, quenching, orientation, heat setting, lamination, coating and solvent casting. It is preferred that the polymer substrate is an oriented sheet formed by any suitable method known in the art, such as by a flat sheet process or a bubble or tubular process. The flat sheet process involves extruding or coextruding the materials of the sheet through a slit die and rapidly quenching the extruded or coextruded web upon a chilled casting drum so that the polymeric component(s) of the sheet are quenched below their solidification temperature.

The quenched sheet is then biaxially oriented by stretching in mutually perpendicular directions at a temperature above the glass transition temperature of the polymer(s). The sheet may be stretched in one direction and then in a second direction or may be simultaneously stretched in both directions. The preferred stretch ratio in any direction is at least 3:1. After the sheet has been stretched, it is heat set by heating to a temperature sufficient to crystallize the polymers while restraining to some degree the sheet against retraction in both directions of stretching.

The polymer sheet may be subjected to any number of coatings and treatments, after extrusion, coextrusion, orientation, etc. or between casting and full orientation, to improve its properties, such as printability, barrier properties, heat-sealability, spliceability, adhesion to other substrates and/or imaging layers. Examples of such coatings can be acrylic coatings for printability, polyvinylidene halide for heat seal properties, etc. Examples of such treatments can be flame, plasma and corona discharge treatment, ultraviolet radiation treatment, ozone treatment and electron beam treatment to improve coatability and adhesion. Further examples of treatments can be calendaring, embossing and patterning to obtain specific effects on the surface of the web. The polymer sheet can be further incorporated in any other suitable substrate by lamination, adhesion, cold or heat sealing, extrusion coating, or any other method known in the art.

The following examples illustrate the practice of this invention. They are not intended to be exhaustive of all possible variations of the invention. Parts and percentages are by weight unless otherwise indicated.

### EXAMPLES

FIGS. #3-#5 illustrate solvent property spaces used in aqueous mixtures to disperse SWCNT's as per this instant invention. The shaded regions depict the most useful space for selecting solvents for dispersing said SWCNT'S. The combinations of solubility parameters and surface tension allow for the most effective dispersing power. In the examples below FIGS. #3-#5 were used to select solvents in order to disperse SWCNT's at various weight percent solvents in the dispersion as shown in the tables #2 and #3.

Ingredients for Coating Compositions (Dispersions)

(a) TX-100: nonionic surfactant supplied by Rohm & Haas

(b) P3 SWCNT: single wall carbon nanotubes with covalently attached carboxylic acids (atomic % described below) supplied by Carbon Solutions Inc.

(c) P2 SWCNT: single wall carbon nanotubes with covalently attached carboxylic acids (atomic % described below) supplied by Carbon Solutions Inc.

(d) RFP SWCNT: single wall carbon nanotubes with covalently attached carboxylic acids (atomic % described below) supplied by Carbon Solutions Inc.

(e) HiPCO SWCNT: single wall carbon nanotubes with covalently attached carboxylic acids (atomic % described below) supplied by Carbon Nanotechnologies Inc.

The atomic % of carboxylic acids on each type of SWCNT has been determined by titration methods as described below. Table 1 indicates the level of carboxylic acids we determined for each SWCNT.

TABLE 1

| | | % of C atoms |
|---|---|---|
| SWCNT | | functionalized by |
| Type | Vendor | COOH (atomic %) |
| P2 | Carbon Solutions Inc. | 0.46 |
| P3 | Carbon Solutions Inc. | 2.74 |
| HiPCO | Carbon Nanotechnologies | 0.11 |
| | Inc. | |
| RFP | Carbon Solutions Inc. | 1.13 |

The methods used to determine the amount of carboxylic acid covalently attached are described below.

The Titrimetric Determination of Strong Acid Levels in Single-Walled Carbon Nanotubes

A nonaqueous titration procedure is given for the determination of strong acid in Single-Walled Carbon Nanotubes (SWCNT). Samples are dispersed in a solvent system of 50/2 (v/v) distilled tetrahydrofuran (THF)/methanol. The dispersion is titrated with 0.1N hexadecyltrimethylammonium hydroxide (HDTMAH).

Typically two end points are recorded. The first is due to stronger acids associated with the SWCNT. These may be residual mineral acid from the surface derivatization reactions or acid functions attached to the SWCNT surface. A second end point is also observed but is typically too noisy to be utilized quantitatively. The strong acid in the SWCNT sample is subtracted from the total acids found by sodium hydroxide back titration to give the net level of carboxylic acid in the SWCNT.

Equipment

1) Metrohm Model 716 Titrino with Brinkmann Titrino Workcell software, or equivalent, and equipped with a 1-ml amberized glass buret.
2) Indicator electrode—combination glass pH/Ag/AgCl reference. Metrohm Model 6.0202.100, or equivalent. The filling solution for the electrode is 0.1N tetramethyl-ammonium chloride in methanol.
   Reagents
1) 0.1N Hexadecyltrimethylammonium hydroxide (HDTMAH) in ˜9:1 (v) toluene:methanol (Note 1).
2) Distilled tetrahydrofuran (THF) (Note 2)
3) Methanol, reagent grade such as J. T. Baker 9093-33.
   Procedure
1) Weigh to the nearest 0.1 mg approximately 30 to 150 mg of the SWCNT sample into a 100 ml beaker (Note 3).
2) Add 50 ml distilled THF and 2 ml methanol.
3) Cover with Parafilm and stir for 15 minutes.
4) Titrate the sample with 0.1N HDTMAH utilizing the Titrino equipped with a 1 ml buret.
5) Titrate a blank of 50/2 THF/MeOH under the same conditions.
   Calculations

The Titroprocessor will mark the potentiometric end point(s) automatically. Only the first end point (positive HNP) is used in the following calculation. Subsequent end points are ignored.
EP=End Point
Strong Acid(meq/g)=[(ml EP#1)−(ml Blank)]×N_{HDTMAH}(grams of sample)
Net Carboxylic Acid(meq/g)=[Total Acids (from NaOH Back-Titration)(meq/g)]−[Strong Acid(meq/g)]
Notes
1) HDTMAH is available as a 25% (w/v) solution in methanol from Acros Organics. Cat # 41142-1000. This material normally needs extensive purification before it is suitable for titrimetric use.
2) THF is distilled to remove the peroxide inhibitor BHT, which interferes with the titration. Distilled THF is a potential peroxide-former and should not be stored for more than 24 hours. Under no circumstances should distilled THF be allowed to evaporate to dryness as the residue is potentially explosive. We have found distillation through a 1 foot Vigreaux column sufficient to remove BHT.)
3) Sample sizes vary widely depending on the expected level of carboxylation on the SWCNT sample. The sample range specified is based on experience thus far.
   The Titrimetric Determination of Total Acid Levels in Single-Walled Carbon Nanotubes

An aqueous titration procedure is given for the determination of total acid in Single-Walled Carbon Nanotubes (SWCNT). Samples are dispersed in water containing an excess of 0.1N NaOH. After sufficient time to react any acid on the SWCNT the excess base is titrated with 0.1N HCl to a potentiometric end point. A blank of 0.1N NaOH without the SWCNT is determined with 0.1N HCl. The total level of acid in the SWCNT sample follows from the difference between the blank and the sample titrations.

Equipment

1) Metrohm Model 716 Titrino with Brinkmann Titrino Workcell software, or equivalent, and equipped with a 1-ml glass buret.
2) Indicator electrode—combination glass pH/Ag/AgCl reference. Metrohm Model 6.0202.100, or equivalent. The filling solution for the electrode is saturated KCl.
   Reagents
1) 0.1N HCl in water. Standardized against 4-aminopyridine (Primary Standard Grade).
2) 0.1N NaOH. Standardized against benzoic acid (Primary Standard Grade).
   Procedure
1) Weigh to the nearest 0.1 mg approximately 30 to 150 mg of the SWCNT sample into a 100 ml beaker (Note 1).
2) Add 50 ml distilled water.
3) By Class A pipet add 1.0 ml 0.1N NaOH.
4) Cover with Parafilm and stir for two hours.
5) Titrate the sample with 0.1N HCl utilizing the Titrino equipped with a 1 ml buret.
6) Titrate a blank of 1.0 ml 0.1N NaOH in 50 ml distilled water under the same conditions.
   Calculations

The Titroprocessor will mark the potentiometric end point(s) automatically. Generally two end points will be seen in both the sample and the blank. The difference between the first end points (hydroxide) should be used in the following calculations.
Total Acids (meq/g)=[(ml HCl at EP #1 Blank)−(ml HCl at EP #1 Sample)]×N_{HCl}(grams of sample)
Notes
1) Sample sizes vary widely depending on the expected level of carboxylation on the SWCNT sample. If known one can calculate an appropriate sample size. If not known one will have to experiment. The sample range specified is based on our experience thus far.

Table 2 below shows the dispersion stability/quality found for the various dispersion types formed where only the functionalized tubes in polar solvent/water are used to form the dispersion. It clearly indicates that with a suitable level of carboxylic acid functionalization and solvent mixture (as per the instant invention) selection, the overall dispersion quality and ability to disperse at higher SWCNT solid loadings is significantly improved. The legend is as follows, where the numerical value assigned has better dispersion properties as it approaches 5:

Rating 1: Dispersion is not stable and forms aggregate quickly and SWCNT's fall out of solution.

Rating 2: Dispersion is less stable with considerable amounts of aggregates that form a silt on the bottom of the container.

Rating 3: Dispersion is good with a low level of silt or aggregates in solution.

Rating 4: Dispersion is very good with lower level of silt or aggregates.

Rating 5: Dispersion is excellent with very low levels of aggregates or silt that are hard to see even after longer periods of settling.

The following table #2 depicts dispersions prepared by adding 0.1% P3 SWCNT's in the given solvent concentrations added to distilled water and sonicated in a bath sonicator for 24 hours. The observations made and ratings assigned illustrate the polar solvent mixtures effect as per the instant invention.

Table #3 shows the dispersions from table #2 were coated by using roll coating methods onto a 101.6 micron substrate. The substrate used was polyethylene terephthalate (PET). The PET substrate was photographic grade with a thickness of 102 m and surface roughness Ra of 0.5 nm. On the coating side (frontside) of the PET a thin vinylidene chloride copolymer primer layer was applied at a thickness of 80 nm.

The sheet resistance, Rₛ, (ohms/square) of the coatings was measured by a 4-point electrical probe. The P3 SWCNT's laydown is given in mg/ft² and the resulting coating appearance is given.

TABLE 2

| | | | Solvent | | |
|---|---|---|---|---|---|
| Dispersion | | Solvent | Concentration in | | |
| number | Description | type | H2O | Dispersion Quality Observation | Rating |
| 1 | Example | Methanol | 5% | very good, low level of silt or | 4 |
| | | | | aggregates | |
| 2 | Example | Methanol | 15% | Excellent, low level of silt or | 5 |
| | | | | aggregates | |
| 3 | Example | Methanol | 25% | Excellent, low level of silt or | 5 |
| | | | | aggregates | |
| 4 | Example | Ethanol | 5% | good, low level of silt or | 3 |
| | | | | aggregates | |
| 5 | Example | Ethanol | 15% | very good, low level of silt or | 4 |
| | | | | aggregates | |
| 6 | Example | Ethanol | 25% | very good, low level of silt or | 4 |
| | | | | aggregates | |
| 7 | Example | Acetone | 5% | very good, low level of silt or | 4 |
| | | | | aggregates | |
| 8 | Example | Acetone | 15% | Excellent, low level of silt or | 5 |
| | | | | aggregates | |
| 9 | Example | Acetone | 25% | Excellent, low level of silt or | 5 |
| | | | | aggregates | |
| 10 | Example | Acetone | 50% | good, some silt or aggregates | 3 |
| 12 | Comparative | Acetone | 100% | not stable, aggregation | 1 |
| 13 | Example | n-propanol | 5% | very good, low level of silt or | 4 |
| | | | | aggregates | |
| 14 | Example | n-propanol | 15% | Excellent, low level of silt or | 5 |
| | | | | aggregates | |
| 15 | Example | n-propanol | 25% | Excellent, low level of silt or | 5 |
| | | | | aggregates | |
| 16 | Comparative | THF | 25% | silt or aggregates, less stable | 2 |
| 17 | Comparative | THF | 100% | not stable, aggregation | 1 |
| 18 | Comparative | MEK | 5% | silt or aggregates, less stable | 2 |
| 19 | Comparative | MEK | 15% | silt or aggregates, less stable | 2 |
| 20 | Comparative | MEK | 25% | not stable, aggregation | 1 |

TABLE 3

| | | | P3 | | |
|---|---|---|---|---|---|
| Dispersion | | Coating ID | Laydown | Rₛ | Coating |
| Number | Description | Number | (mg/ft2) | (Ohms/Square) | appearance |
| 1 | Example | 592 | 2 | 15,760 | Very good |
| 2 | Example | 594 | 2 | 3,812 | Very good |
| 3 | Example | 599 | 2 | 6,098 | Very good |
| 4 | Example | 600 | 2 | 11,078 | good |
| 5 | Example | 603 | 2 | 6,366 | good |
| 6 | Example | 608 | 2 | 7,524 | good |
| 7 | Example | 582 | 2 | 6,288 | good |
| 8 | Example | 587 | 2 | 6,818 | good |
| 9 | Example | 588 | 2 | 7,782 | Very good |
| 10 | Example | 337 | 1.5 | 12,320 | good |
| 12 | Comparative | Could not coat this level | | | |
| 13 | Example | 616 | 2 | 9,112 | good |
| 14 | Example | 620 | 2 | 3,320 | Very good |
| 15 | Example | 623 | 2 | 6,622 | Very good |
| 16 | Comparative | 332 | 1.5 | 11,000 | Very poor |
| 17 | Comparative | Could not coat this level | | | |
| 18 | Comparative | 635 | 2 | 16,820 | poor |
| 19 | Comparative | 636 | 2 | 12,242 | Very poor |

| | | |
|---|---|---|
| 20 | Comparative | Could not coat this level |

As seen by the examples above, when dispersions and their subsequent coating were prepared outside of the aforementioned plot specifications (FIGS. 3,4 and 5) or at polar solvent levels above 50% the comparative result was aggregated dispersions below a 3 rating and when coated gave poor appearance, low conductivity or were not coatable. Examples of this invention maintained a 3 or better dispersion rating (as contrasted with the comparative examples) and when coated were good or very good in appearance and achieved good conductivity.

The invention has been described in detail with particular reference to certain preferred embodiments thereof, but it will be understood that variations and modifications can be effected within the spirit and scope of the invention.

1. A method of forming a dispersion comprising providing functionalized carbon nanotubes with covalently attached hydrophilic species, adding said carbon nanotubes to an aqueous solution of polar solvent, and dispersing said carbon nanotubes in said aqueous solution.

2. The method of claim 1 wherein said solvent has a boiling point of between 30° C. and 150° C.

3. The method of claim 1 wherein said solvent is selected from the group consisting of methanol, isopropyl alcohol, n-propyl alcohol, ethanol, acetone, and mixtures thereof.

4. The method of claim 1 wherein said solvent has an evaporation rate range between 50 and 2000 relative to n-butyl acetate.

5. The method of claim 1 wherein said solvent has a hydrogen bonding solubility parameter of between 10.2 and 27 (MPa)^{1/2} and a polar solubility parameter of between 9.5 and 14 (MPa)^{1/2}.

6. The method of claim 5 wherein said solvent has a surface tension of between 14 and 30 milliNewtons per meter.

7. The method of claim 1 wherein said dispersion is substantially surfactant free.

8. The method of claim 1 wherein said polar solvent is present in an amount of between 3 and 25 percent of said aqueous solution.

9. The method of claim 1 wherein said aqueous solution further includes a coating aid.

10. The method of claim 1 wherein said aqueous solution further includes polymeric binders.

11. The method of claim 1 wherein said carbon nanotubes comprise single wall carbon nanotubes with covalently attached hydrophilic species selected from the group consisting of carboxylic acid, nitrates, hydroxyls, sulfur containing groups, carboxylic acid salts, and phosphates, in an amount of at least 0.5 atomic % of said carbon nanotubes, wherein said carbon nanotubes are present in an amount of at least 0.05 wt. % of said dispersion.

12. The method of claim 1 wherein the pH of said dispersion is between 3 and 10.

13. The method of claim 1 wherein said carbon nanotubes are present in an amount of between 0.05 and 10% of said dispersion.

14. The method of claim 1 wherein said carbon nanotubes are present in an amount of between 0.05 and 1% of said dispersion.

15. The method of claim 1 wherein the hydrophilic species is present in an amount of between 0.5 and 5 atomic %.

16. The method of claim 1 wherein said hydrophilic species comprises carboxylic acid or carboxylic acid salt or mixtures thereof.

17. The method of claim 1 wherein said hydrophilic species comprises a sulfur containing group selected from:
SOₓZ_{y}
Wherein x may range from 1-3 and Z may be a Hydrogen atom or a metal cation such metals as Na, Mg, K, Ca, Zn, Mn, Ag, Au, Pd, Pt, Fe, Co and y may range from 0 or 1.

18. The method of claim 1 wherein said carbon nanotubes have an outer diameter of between 0.5 and 5 nanometers.

19. The method of claim 1 wherein said carbon nanotubes have a length of between 20 nanometers and 50 microns.

20. The method of claim 1 wherein said carbon nanotubes comprise bundles of a length of between 20 nanometers and 50 microns after dispersing.

21. The method of claim 1 wherein said carbon nanotubes are metallic carbon nanotubes.

22. The method of claim 1 wherein said hydrophilic species comprises sulfonic acids or sulfonic acid salts or mixtures thereof.

23. The method of claim 1 wherein said carbon nanotubes are open end carbon nanotubes.

24. The method of claim 1 wherein said covalently attached hydrophilic species is present on the outside wall of said carbon nanotube.

25. A method of forming a conductive layer comprising providing a dispersion comprising functionalized carbon nanotubes with covalently attached hydrophilic species in an aqueous solution of polar solvent, coating said dispersion onto a substrate, and removing said aqueous solution of polar solvent to form a layer of carbon nanotubes.

26. The method of claim 25 wherein said removing said aqueous solution of polar solvent is carried out until said layer is substantially free of polar solvent.

27. The method of claim 25 wherein said aqueous solution of polar solvent is entirely volatile.

28. The method of claim 25 wherein said dispersion is substantially free of dispersing surfactant.

29. The method of claim 25 wherein said dispersion further comprises a coating aid that does not substantially increase the layer electrical resistance after drying in comparison with a layer formed without a coating aid.

30. The method of claim 25 wherein said coating is roll coating.

31. The method of claim 25 wherein said coating is by ink jet.

32. The method of claim 25 wherein said solvent has a boiling point of between 30° C. and 150° C.

33. The method of claim 25 wherein said solvent is selected from the group consisting of methanol, isopropyl alcohol, n-propyl alcohol, ethanol, acetone, and mixtures thereof.

34. The method of claim 25 wherein said solvent has an evaporation rate of between 50 and 2000 relative to n-butyl acetate.

35. The method of claim 25 wherein said solvent has a surface tension of between 14 and 30 milliNewtons per meter.

36. The method of claim 25 wherein said solvent has a hydrogen bonding solubility parameter of between 10.2 and 27 (MPa)^{1/2} and a polar solubility parameter of between 9.5 and 14 (MPa)^{1/2}.

37. The method of claim 35 wherein said solvent has a hydrogen bonding solubility parameter of between 4 and 13 (cal/cm³)^{1/2}.

38. The method of claim 25 wherein said polar solvent is present in an amount of between 3 and 25 percent of said aqueous solution.

39. The method of claim 25 wherein said aqueous solution further includes a coating aid.

40. The method of claim 25 wherein said aqueous solution further includes polymeric binders.

41. The method of claim 25 wherein said carbon nanotubes comprise single wall carbon nanotubes with covalently attached hydrophilic species selected from the group consisting of carboxylic acid, nitrates, hydroxyls, sulfur containing groups, carboxylic acid salts, and phosphates, in an amount of at least 0.5 atomic % of said carbon nanotubes, wherein said carbon nanotubes are present in an amount of at least 0.05 wt. % of said dispersion.

42. The method of claim 25 wherein said carbon nanotubes are present in an amount of between 0.05 and 10% of said dispersion.

43. The method of claim 25 wherein the hydrophilic species is present in an amount of between 0.5 and 5 atomic %.

44. The method of claim 25 wherein said hydrophilic species comprises carboxylic acid or carboxylic acid salt or mixtures thereof.

45. The method of claim 25 wherein said hydrophilic species comprises a sulfur containing group selected from:
SOₓZ_{y}
Wherein x may range from 1-3 and Z may be a Hydrogen atom or a metal cation such metals as Na, Mg, K, Ca, Zn, Mn, Ag, Au, Pd, Pt, Fe, Co and y may range from 0 or 1.

46. The method of claim 25 wherein said carbon nanotubes have an outer diameter of between 0.05 and 5 nanometers.

47. The method of claim 1 wherein said carbon nanotubes have a length of between 20 nanometers and 50 microns.

48. The method of claim 1 wherein said carbon nanotubes are metallic carbon nanotubes.

49. The method of claim 1 wherein said hydrophilic species comprises sulfonic acids or sulfonic acid salts or mixtures thereof.
